(19) United States
(12) Patent Application Publication
(10) Pub. No.: US 2007/0067476 A1
(43) Pub. Date: Mar. 22, 2007

(54) Quality of service management for service grids

(76) Inventors: Anssi Karhinen, Vantaa (FI); Juha E. Savolainen, Helsinki (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 11/482,092

(22) Filed: Jul. 7, 2006

Related U.S. Application Data
(60) Provisional application No. 60/697,375, filed on Jul. 8, 2005.

(51) Int. Cl. G06F 15/16

(52) U.S. Cl. 709/230

(57) ABSTRACT

The present invention provides a system and method for predicting and managing end-to-end quality of service (QoS) and capacity in systems using a telecommunication service grid architecture. A Service Level Specification (SLS) is provided to specify a service offered by the service grid. A Service Level Agreement (SLA) is provided to specify capacity and quality of service (QoS) characteristics between a client and the service. The client then instantiates the SLA with the service running on the service grid, and a grid node is provided to host a service configuration with the specified capacity and quality of service (QoS).

### CROSS REFERENCE TO RELATED APPLICATIONS

This application claims the benefit of U.S. Provisional Application Ser. No. 60/697,375 filed on Jul. 8, 2005. The information contained in the provisional application is hereby incorporated by reference.

### BACKGROUND OF THE INVENTION

1. Field of the Invention

The present invention relates to software service grids, and, more specifically, to a framework for predicting and managing end-to-end quality of service (QoS) and capacity in systems using a telecommunication service grid architecture.

2. Description of the Related Art

Grid software technology is a vital part of the emerging field of “Utility Computing” which aims to commoditize the physical or logical resources in computing systems. A grid uses different virtualization techniques to offer the underlying physical resources to software applications in a transparent manner so that the physical resources can be managed separately from the running software applications.

A commonly used analogy for grids in computer science is a power grid which can provide electricity to a multitude of different clients in a completely transparent fashion. In other words, a user of the power grid has no way of determining the original source of the electricity he is using.

Different versions of grid techniques are available in the area of computer science. The earliest version is the virtualization batch computing systems where the user of the grid is able to submit computing tasks into a virtual batch scheduling system that transparently distributes them to be executed on available computing resources in the grid. These types of systems are typically used for large scientific computing tasks that can be parallelized into a multitude of sequential jobs. They represent mature grid technology that has been deployed across various domains.

Recently, there has been strong development of more generally applicable grid technology called “service grids”. Service grids are based on Service Oriented Architecture (SOA) principles where software applications are composed of sets of distributed services that each encapsulates a body of reusable business logic. The service grids enhance SOA concepts by bringing in mechanisms to dynamically manage the physical resources that the services use and hide them from the applications.

Service grids are currently an emerging paradigm in the enterprise computing field. They can be used to radically improve the average utilization of existing hardware resources, to lower the initial investment costs needed to deploy new software applications, to enable new service business models such as “pay-per-use” and to offer more seamless management of resources and applications.

In the telecommunications industry, the non-functional requirements for software applications that implement subscriber services are typically more demanding than in business or scientific computing. Requirements for service availability, performance, scalability and quality are often defined by international telecommunications standards or are required to be defined in precise terms by operators of services and network infrastructure. In such an environment, being able to confidently specify the non-functional characteristics of provided service implementations is a major business requirement for a vendor of telecommunication infrastructure and applications.

Service grids have yet to be applied to the telecommunications sector because the ability to predict the capacity and quality of the services running on the grid has been difficult and thus far not feasible. The problem arises from the fact that a service grid typically tries to maximize the overall utilization of the underlying hardware resources while not monitoring the effects that the interference between numerous services competing for the same resources has on the quality and capacity of those services.

Therefore, there is a need for a system and method for predicting and managing end-to-end quality of service (QoS) and capacity in systems using a telecommunication service grid architecture.

### SUMMARY OF THE INVENTION

According to an embodiment of the invention, a method of dynamic quality of service (QoS) and capacity management in a telecommunication service grid is provided. The method may include providing a Service Level Specification (SLS) for specifying a service offered by the service grid, providing a Service Level Agreement (SLA) for specifying capacity and quality of service (QoS) characteristics between a client and the service. The method may further include instantiating, by the client, the SLA with the service running on the service grid, and providing a grid node for hosting a service configuration with the specified capacity and quality of service (QoS).

According to another aspect of the invention, a system providing dynamic quality of service (QoS) and capacity management in a telecommunication service grid is provided. The system may include a client interface for communicating with a client of the service grid, a service running on the service grid, a Service Level Specification (SLS) configured to specify the service offered by the service grid, a Service Level Agreement (SLA) configured to specify capacity and quality of service (QoS) characteristics between the client and the service, and a grid node configured to host a service configuration with the specified capacity and quality of service.

According to a further embodiment of the invention, a method for instantiating a Service Level Agreement (SLA) on a telecommunication service grid is provided. The method may include selecting an SLA with a required capacity and quality of service for a service, and locating a grid node with a hosting configuration that has a hosting level agreement (HLA) for the service, the HLA having sufficient remaining capacity to satisfy the SLA.

According to another example of the invention, a network node running on a service grid is provided. The network node may include a selection unit for selecting an SLA with a required capacity and quality of service for a service, and a location unit for locating a grid node with a hosting configuration that has a hosting level agreement (HLA) for the service. The HLA should have sufficient remaining capacity to satisfy the SLA.

According to another embodiment of the invention, a network node running on a service grid is provided. The network node may include means for selecting an SLA with a required capacity and quality of service for a service, and means for locating a grid node with a hosting configuration that has a hosting level agreement (HLA) for the service. The HLA should have sufficient remaining capacity to satisfy the SLA.

According to another aspect of the invention, a computer program product embodied on any computer readable medium is provided. When the computer program is executed, the following instructions are performed: providing a Service Level Specification (SLS) for specifying a service offered by the service grid, providing a Service Level Agreement (SLA) for specifying capacity and quality of service (QoS) characteristics between a client and the service, instantiating, by the client, the SLA with the service running on the service grid, and providing a grid node for hosting a service configuration with the specified capacity and quality of service (QoS).

### BRIEF DESCRIPTION OF THE DRAWINGS

For proper understanding of the invention, reference should be made to the accompanying drawings, wherein:

FIG. 1A illustrates a block diagram of the use of end services by an end user according to one embodiment of the invention;

FIG. 1B illustrates a block diagram of the use of end services by multiple end users according to an embodiment of the invention;

FIG. 2 illustrates a method according to one embodiment of the invention;

FIG. 3 illustrates a method according to another embodiment of the invention;

FIG. 4 illustrates an object model according to an embodiment of the invention;

FIG. 5 illustrates a system according to one embodiment of the invention; and

FIG. 6 illustrates a system according to another embodiment of the invention;

### DETAILED DESCRIPTION OF THE PREFERRED EMBODIMENT(S)

In view of the utility of service grids, as discussed above, the present invention seeks to apply the service grid architecture to the telecommunications sector. According to one aspect of the invention, therefore, a telecommunications service grid with predictable and deterministic end-to-end quality of service (QoS) and capacity is provided.

Quality of service (QoS) is generally a term which refers to the probability of the telecommunications network meeting a given traffic contract, or may refer to the probability of a packet succeeding in passing between two points in the network. In addition, as applied to the field of telephony, QoS may refer to lack of noise and tones on the circuit, and/or appropriate loudness levels. Generally, when mechanisms for ensuring a certain QoS are required, customers and providers may enter into an agreement termed a Service Level Agreement (SLA) which specifies guarantees for the ability of a network or protocol to provide guaranteed performance and throughput based on mutually agreed measures. The application of SLAs in the present application will be discussed in further detail below.

According to an example of the invention, hardware capabilities are partitioned into discrete collections of possible service combinations that can be hosted on each hardware node in the service grid. These combinations form a space where configurations for different purposes may be formed for the whole grid. The partitioning of hardware capabilities may be made, for example, by an iterative testing process designed to find suitable service hosting configurations for the different nodes.

Traditional implementations of service grids, in contrast, rely on dynamic allocation of resources to the services. Such an approach has the drawback that the call might fail because of a lack of resources, in addition to the execution characteristics being unpredictable. Previous systems also were known to allocate resources through the use of matchmaking algorithms. These algorithms require that the hardware resources be modeled using some generic concept such as the speed of the CPU, amount of memory, disc space, etc.

Existing service grids do not have mechanisms to present and manage the capacity and quality dependencies between services. As an example, two end user services A and B may both use a third service C as a part of their implementation. In addition, all the service instances are running on different hardware nodes and only one instance of each service exists.

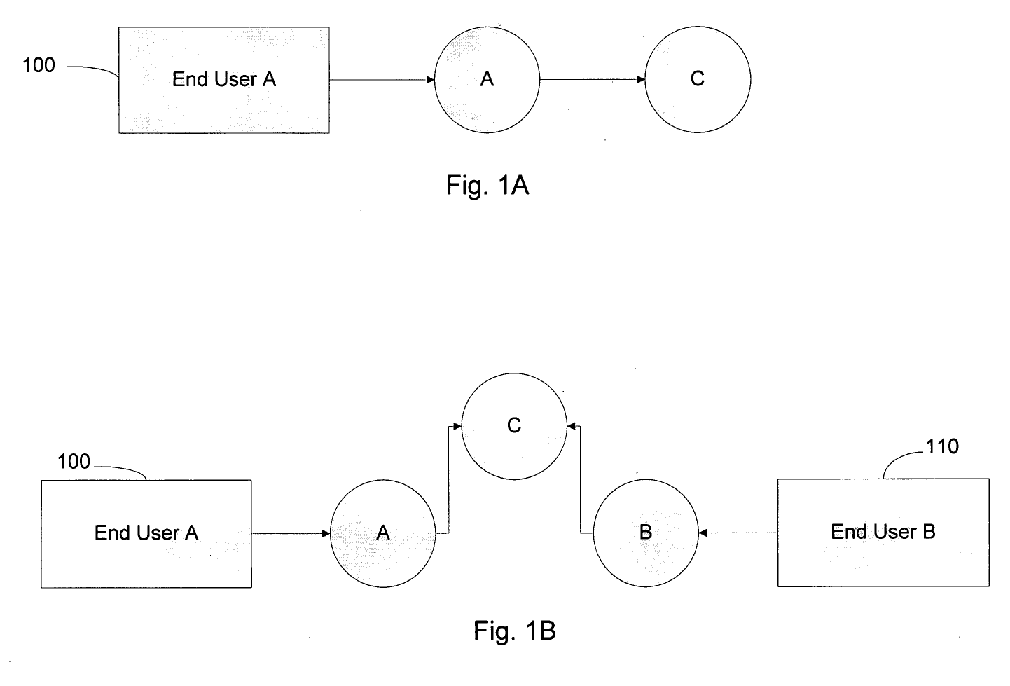

As illustrated in FIG. 1A, if only end user service A and service C are running they will provide end-user A 100 with certain quality of service and capacity for end user service A that depends on the capabilities and capacity hardware resources the services have been instantiated on. End user service A will use either all or part of the capacity that the service C is able to offer. In such a situation, the prediction of quality and capacity of end user service A is straight forward and can be confidently predicted though various available methods including modeling, simulation, and testing.

However, as illustrated in FIG. 1B, another end user 110 may begin to use end user service B, which in turn uses service C. Now, because end user service B is using the same instance of service C as end user service A, the quality of service and capacity of end user service A can be depleted if service C is no longer capable of supplying A with enough capacity to maintain the original levels. As such, the qualities and capacities of end user services A and B are connected via a dependency function that is difficult to define since it would require a detailed model of the capacity and quality strain that usage patterns by end user services A and B cause to service C. In practice, such models have turned out to be too complex and prone to errors to be useful.

A reliable guarantee for the quality and capacity of end user services A and B may be provided, however, by simulating or testing them with a finite amount of load combinations. In this manner, it may be determined, for example, that “A will serve 1000 requests per second with 450 ms delay and B will serve 600 requests per second with 800 ms delay” or “A will serve 500 requests per second with 450 ms delay and B will serve 800 requests per second with 750 ms delay.”

The situation described above changes radically in a service grid that can dynamically move the service instances between hardware nodes and create new service instances in order to maximize the overall utilization level of the hardware nodes. This clearly leads to a combinatorial explosion of quality and capacity dependencies among service instances as a collection of N service instances can be deployed on M hardware nodes in M^{N} different combinations. All combinations would have different dependency functions between the QoS and capacity of the services.

Therefore, applications that currently have been implemented using service grids exhibit QoS behavior that is very difficult to predict and manage.

According to an embodiment of the present invention, a feasible framework to predict and manage end-to-end service QoS and capacity in systems using Service Grid architecture is provided. Clients of the grid can instantiate, in advance or on demand, a Service Level Agreement (SLA) with a service running on the grid. The framework of the present invention uses a recursive algorithm to reserve resources from the grid nodes to ensure the promised QoS and capacity for the service and all the other services required by it. An instantiated SLA constitutes an end-to-end “QoS-pipe” through the service grid.

The grid can still be dynamically reconfigured by storing different combinations of pre-instantiated SLAs and switching between them to adapt the service capacities and QoS to different traffic patterns in the grid or other dynamic requirements. The present invention may avoid the complexities of matchmaking algorithms based on resource ontologies and generic QoS metrics. Combinatorial space of different service configurations per each grid node is reduced to a fixed collection of pre-formed service combinations with known capacity and QoS properties. An embodiment of the present invention may be based on generating sufficient empirical capacity and QoS data points through testing to make dynamic and non-trivial QoS and capacity management possible.

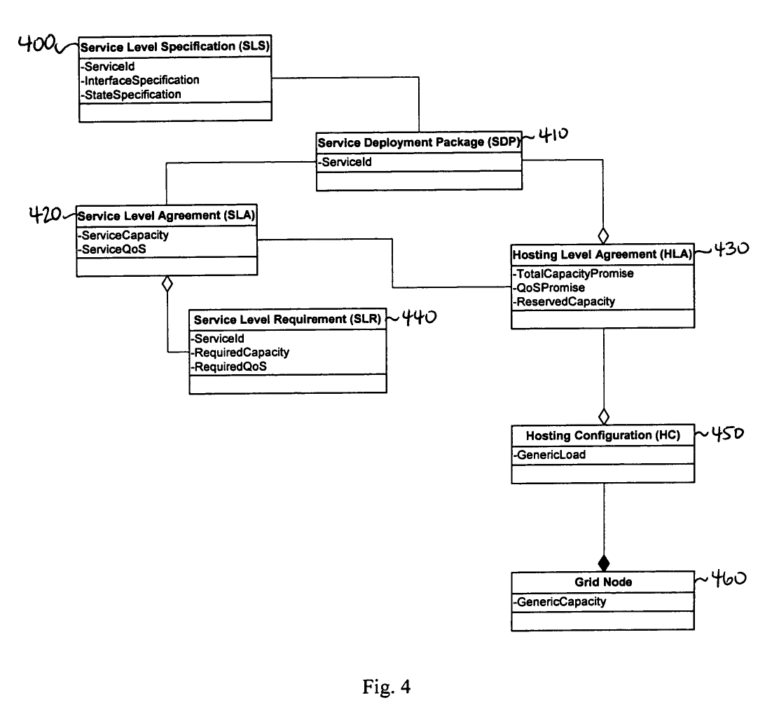

FIG. 4 illustrates an object model including the services provided according to one example of the invention. A grid node 460 can host services in different, predetermined Hosting Configurations (HC) 450. The total capacity and QoS may be specified and verified through testing for each service in each configuration and is modelled by a Hosting Level Agreement (HLA). A grid node 460 can host one service configuration at a time with the promised capacity and QoS for each service in the configuration providing that all other services that are needed by the services in the configuration are available in sufficient capacity and QoS.

A Service Level Specification (SLS) 400 specifies a service offered by the grid in syntactic terms. It enumerates the service functions and specifies their parameters and required data structures. A client of the service needs only the SLS and a reference to a service instance to be able to use the service.

A Service Level Agreement (SLA) 420 is an entity that specifies certain capacity and QoS characteristics between a client of the grid and a service offered by the grid. SLA 420 is needed by the client of the service to ensure that the service instance the client is using has sufficient capacity and adequate QoS for the client application.

A Service can have many different implementations. In the present invention, according to one embodiment, a service implementation is modelled by a Service Deployment Package (SDP) 410. Each implementation is capable of offering an SLA 420 given that other services needed by it are also available. Service Level Requirements (SLR) 440 specifies these requirements.

SLS 400, SLA 420 and SLR 440 specify the logical service characteristics of syntax, capacity and quality of service and requirements for other services. To actually deploy the services to the Grid Nodes these concepts need to be mapped to the Hosting Level Agreements 430. The Service Deployment Package 410 acts as the linking entity to achieve this.

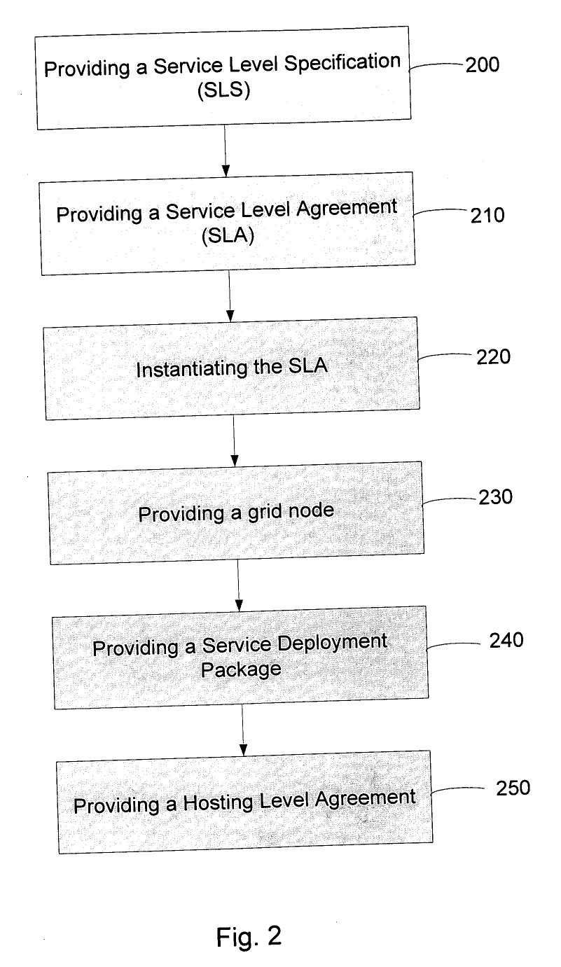

In view of the general framework discussed above, FIG. 2 illustrates a method according to one embodiment of the invention. The method includes providing a Service Level Specification (SLS) which specifies a service offered by the grid in syntactic terms 200, and providing a Service Level Agreement (SLA) which specifies certain capacity and QoS characteristics between a client of the grid and a service offered by the grid 210. The SLA is then instantiated by a client of the grid with the service running on the grid 220. A grid node is provided for hosting a service configuration with the specified capacity and QoS 230. A Service Deployment Package (SDP) may also be provided for modeling an implementation of the service 240. Each implementation may be capable of offering an SLA given that other services needed by the implementation are also available. Furthermore, a Hosting Level Agreement (HLA) may be provided for modeling the total capacity and QoS 250.

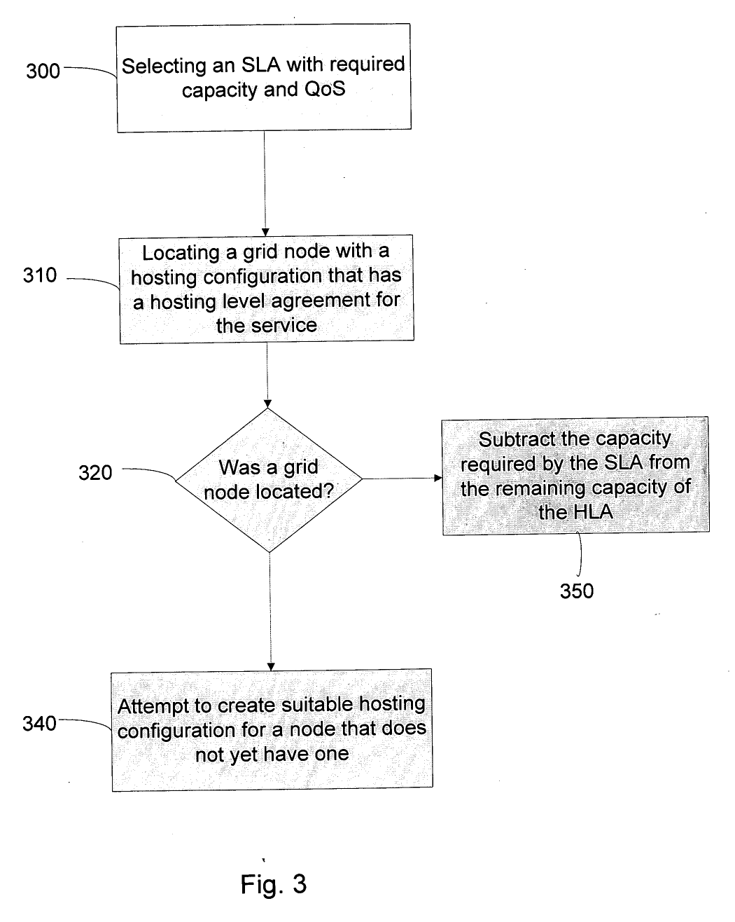

According to another aspect of the invention, a method for instantiating an SLA on the service grid is provided, as illustrated in FIG. 3. The method may include selecting an SLA with the required capacity and QoS for the service 300. The method may further include locating a grid node with a Hosting Configuration that has a Hosting Level Agreement for the service with sufficient remaining capacity to satisfy the SLA 310. Depending on whether an appropriate grid node is located 320, the method may proceed in different ways. If an appropriate grid node is not located, then an attempt is made to create a suitable Hosting Configuration for a node that does not yet have one 340. If the attempt to create a suitable Hosting Configuration fails, then a “Grid configuration rearrange” algorithm, discussed in further detail below, is executed and the method is restarted from initial step 300. If, however, an appropriate node was found, then the capacity required by SLA is subtracted from the remaining capacity of the HLA 330 and a suitable SLA for each SLR required by the current SLA is recursively found.

An instantiated SLA guarantees the capacity and QoS for the corresponding service. It has all the needed resources reserved in the Grid Nodes and protected from other services. In one aspect, an instantiated SLA represents a “pipe” through the grid for an end-to-end execution of given service with know capacity and QoS.

The “Grid configuration rearrange”-algorithm is a search algorithm that tries to find a new combination of Hosting Configurations for the Grid Nodes that will satisfy the already instantiated SLAs and the current SLA that is being instantiated. It is possible to instantiate the needed SLAs in advance by hand for the QoS and capacity management to work.

In an embodiment of the present invention, the capacity metrics used in SLRs and HLAs are comparable and additive. The SLR required capacity is compared to the one offered by HLA and the amount of capacity required by an SLR is subtracted from the capacity of the selected HLA to ensure offered capacity levels are not exceeded. Typical capacity metrics may be, for example, “transactions/second”, “busy hour call attempts” and “kilobytes/second”. Capacity metrics can be different for each service domain.

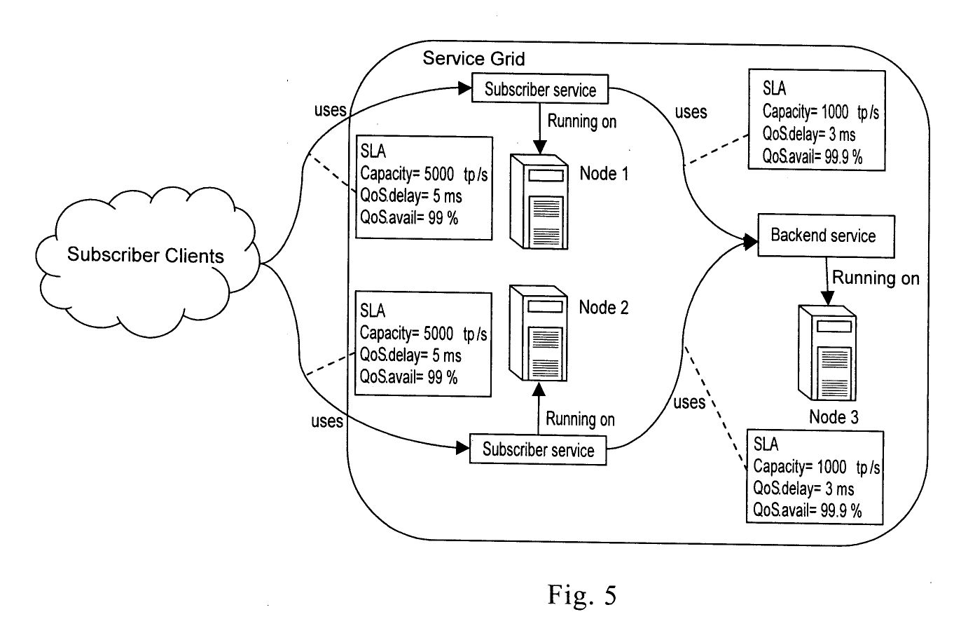

FIG. 5 illustrates a configuration of a service grid 550 according to one embodiment of the invention. The service grid 550 includes one service, Subscriber Service 510, exposed to external clients and running on Node 1 and Node 2, respectively. Subscriber Service 510 is exposed through two SLAs 520, 530 having equal capacity and QoS. Subscriber Service 510 requires the functions of Back End Service 540 which is running on Node 3. The application of SLA instantiation algorithm for the two SLAs 520, 530 produces two end-to-end service pipes as illustrated. According to this embodiment of the invention, total subscriber capacity available to external clients may be 10000 tp/s with an average delay of 5 ms and an availability of 99%.

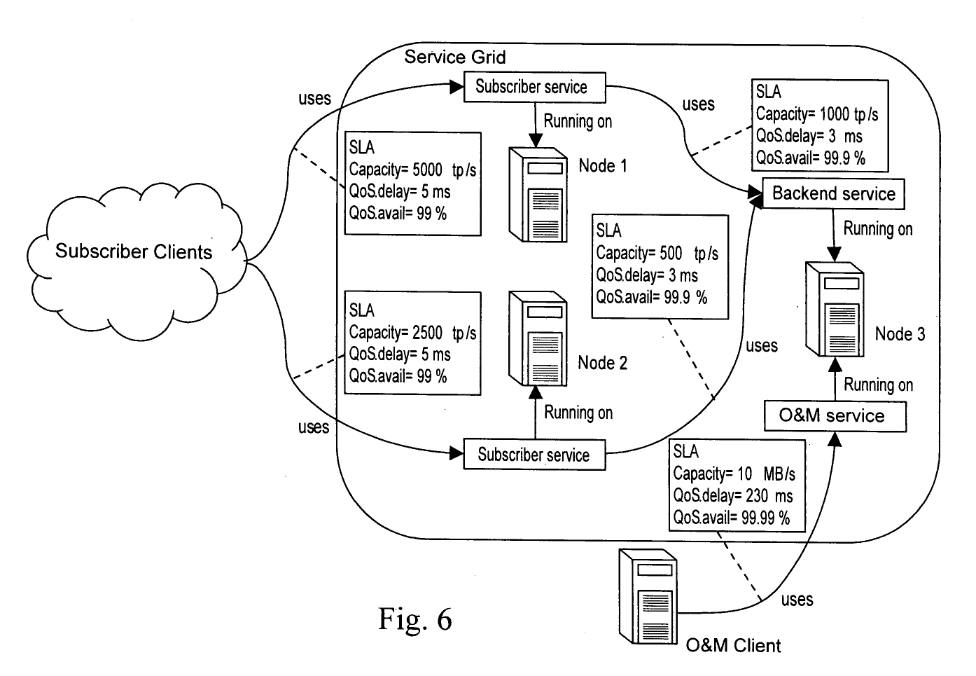

FIG. 6 illustrates a different capacity and QoS configuration of the service grid 550 as may be applied during evening hours, for example, when a certain operations and management (O&M) service 600 needs to be executed. Node 3 is capable of executing the required function but is not capable of simultaneously hosting the two SLAs 520, 530 with capacity of 1000 tp/s for the Backend Service 540. Consequently, an alternative configuration may be applied in advance to allow Node 3 to host O&M Service 600.

As illustrated in FIG. 6, the capacity of the lower pipe 630 has been reduced to 2500 tp/s thus relaxing the capacity requirement for Node 3. Old SLAs for the lower pipe have been exchanged with new SLAs with reduced capacity and the new SLA has been instantiated for the O&M Service 600.

Now the total capacity offered by the grid 550 for the subscriber clients has been reduced to 7500 tp/s but the quality of the service remains the same. Thus, the O&M function 600 can be run at guaranteed capacity and QoS without disrupting the subscriber functions.

As discussed above, the application of service grids to telecommunication networks require a feasible QoS and capacity management system. Accordingly, the present invention, through the various embodiments discussed herein, offers a practical way of supporting end-to-end service capacity and QoS guarantees while still allowing for dynamic capacity and QoS management as the needs for resources change. The present invention, therefore, provides a compromise between completely dynamic “best-effort” service execution and completely static “stove-pipe” partitioning of available resources while still making dynamic optimization or resource utilization possible in the service grid.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

We claim:

1. A method of dynamic quality of service (QoS) and capacity management in a telecommunication service grid, the method comprising:
providing a Service Level Specification (SLS) for specifying a service offered by the service grid;
providing a Service Level Agreement (SLA) for specifying capacity and quality of service (QoS) characteristics between a client and the service;
instantiating, by the client, the SLA with the service running on the service grid; and
providing a grid node for hosting a service configuration with the specified capacity and quality of service (QoS).

2. The method of claim 1, further comprising:
providing a Service Deployment Package (SDP) for modeling an implementation of the service,
wherein each implementation is capable of offering an SLA given that other services needed by the implementation are also available.

3. The method of claim 1, further comprising:
providing a Hosting Level Agreement (HLA) for modeling the total capacity and quality of service (QoS) of the telecommunication service grid.

4. The method of claim 1, wherein the SLS enumerates service functions and specifies parameters of the service functions and required data structures.

5. The method of claim 1, further comprising:
checking, by the client, the SLA to ensure that a service instance which the client is currently using has sufficient capacity and quality of service (QoS) for a client application.

6. A system providing dynamic quality of service (QoS) and capacity management in a telecommunication service grid, the system comprising:
a client interface for communicating with a client of the service grid;
a service running on the service grid;
a Service Level Specification (SLS) configured to specify the service offered by the service grid;
a Service Level Agreement (SLA) configured to specify capacity and quality of service (QoS) characteristics between the client and the service; and
a grid node configured to host a service configuration with the specified capacity and quality of service.

7. The system of claim 6, further comprising:
a Service Deployment Package (SDP) configured to model an implementation of the service,
wherein the implementation is capable of offering an SLA given that other services needed by the implementation are also available.

8. The system of claim 6, further comprising:
a Hosting Level Agreement (HLA) configured to model the total capacity and quality of service (QoS) of the telecommunication service grid.

9. The system of claim 6, wherein the SLS enumerates service functions and specifies parameters of the service functions and required data structures.

10. The system of claim 6, wherein the client checks the SLA to ensure that a service instance which the client is currently using has sufficient capacity and quality of service (QoS) for a client application.

11. A method for instantiating a Service Level Agreement (SLA) on a telecommunication service grid, the method comprising:
selecting an SLA with a required capacity and quality of service for a service; and
locating a grid node with a hosting configuration that has a hosting level agreement (HLA) for the service,
wherein the HLA has sufficient remaining capacity to satisfy the SLA.

12. The method of claim 11, wherein, when a grid node with the hosting configuration that has the hosting level agreement with sufficient remaining capacity is located, the capacity required by the SLA is subtracted from the remaining capacity of the HLA.

13. The method of claim 11, wherein, when a grid node with the hosting configuration that has the hosting level agreement with sufficient remaining capacity is not located, a suitable hosting configuration is created for a node.

14. A network node running on a service grid, the network node comprising:
a selection unit for selecting a Service Level Agreement (SLA) with a required capacity and quality of service for a service; and
a location unit for locating a grid node with a hosting configuration that has a hosting level agreement (HLA) for the service,
wherein the HLA has sufficient remaining capacity to satisfy the SLA.

15. The network node of claim 14, wherein, when a grid node with the hosting configuration that has the hosting level agreement with sufficient remaining capacity is located, the capacity required by the SLA is subtracted from the remaining capacity of the HLA.

16. The network node of claim 14, wherein, when a grid node with the hosting configuration that has the hosting level agreement with sufficient remaining capacity is not located, a suitable hosting configuration is created for a node.

17. A network node running on a service grid, the network node comprising:
selecting means for selecting an SLA with a required capacity and quality of service for a service; and
locating means for locating a grid node with a hosting configuration that has a hosting level agreement (HLA) for the service,
wherein the HLA has sufficient remaining capacity to satisfy the SLA.

18. The network node of claim 17, wherein, when a grid node with the hosting configuration that has the hosting level agreement with sufficient remaining capacity is located, the capacity required by the SLA is subtracted from the remaining capacity of the HLA.

19. The network node of claim 17, wherein, when a grid node with the hosting configuration that has the hosting level agreement with sufficient remaining capacity is not located, a suitable hosting configuration is created for a node.

20. A computer program product, embodied on a computer readable medium, wherein, when the computer program is executed, the following instructions are performed:
providing a Service Level Specification (SLS) for specifying a service offered by the service grid;
providing a Service Level Agreement (SLA) for specifying capacity and quality of service (QoS) characteristics between a client and the service;
instantiating, by the client, the SLA with the service running on the service grid; and
providing a grid node for hosting a service configuration with the specified capacity and quality of service (QoS).
